(19) United States
(12) Patent Application Publication
(10) Pub. No.: US 2024/0209125 A1
(43) Pub. Date: Jun. 27, 2024

(54) PREPOLYMERIZED CATALYST COMPONENTS FOR THE POLYMERIZATION OF OLEFINS

(71) Applicant: Basell Poliolefine Italia S.r.l., Milano (IT)

(72) Inventors: Benedetta Gaddi, Ferrara (IT); Gianni Colina, Ferrara (IT); Nicola Pazi, Ferrara (IT); Ofelia Fusco, Ferrara (IT); Paolo Vincenzi, Ferrara (IT); Maria Di Diego, Ferrara (IT); Giorgia Panno, Ferrara (IT); Simone De Cicco, Ferrara (IT); Giuseppina Maria Algozzini, Ferrara (IT)

(73) Assignee: Basell Poliolefine Italia S.r.l., Milano (IT)

(21) Appl. No.: 18/287,152

(22) PCT Filed: Apr. 8, 2022
(86) PCT No.: PCT/EP2022/059491

§ 371 Date: Oct. 16, 2023

(30) Foreign Application Priority Data
Apr. 16, 2021 (EP) 21168741.3

(51) Int. Cl. C08F 4/50; C08F 2/34; C08F 110/02; C08F 110/06

(52) U.S. Cl. CPC C08F 4/50; C08F 2/34; C08F 110/02; C08F 110/06

(57) ABSTRACT

A prepolymerized catalyst component for the polymerization of olefins made from or containing (i) a solid catalyst component made from or containing Ti, Mg, and an internal donor mixture (IDM) made from or containing (a) from 15 to 75% of 1,3-diethers and (b) from 25 to 85% of succinates based on the total amount of 1,3-diethers and succinates, and (ii) an amount of an ethylene polymer ranging from 0.1 up to 3 g per g of the solid catalyst component (i), wherein the prepolymerized catalyst component has an intrinsic viscosity [η] in tetraline at 135° C. ranging from 2.5 to 5.20 dl/g.

### FIELD OF THE INVENTION

In general, the present disclosure relates to the field of chemistry. More specifically, the present disclosure relates to polymer chemistry. In particular, the present disclosure relates to prepolymerized catalyst components for the polymerization of olefins.

### BACKGROUND OF THE INVENTION

In some instances, gas-phase processes are used for the polymerization of olefins, including propylene.

In some instances, reactor throughput is pushed by increasing gas mass flow rate to the limit of fluidization gas velocity. In some instances, exceeding this limit entrains polymer particles in the recirculation gas, thereby causing gas recirculation pipe and fan sheeting as well as heat exchangers tubes and distribution grid plugging.

It is believed that entrainment velocity is a direct function of particle size and density. It is further believed that bigger or more dense particles allow higher fluidization gas velocity. Accordingly, it is further believed that polymer density, at the application grade's maximum value, facilitates optimization of the gas velocity.

As used herein, the term “fines” refers to small polymeric fractions. In some instances, fines are generated by irregular catalyst fragmentation during the initial stages of polymerization. In some instances, fines cause fouling phenomena such as sheeting of the reactor or auxiliary apparatuses.

In some instances, prepolymerized catalysts are used to make the catalyst particles bigger and decrease the potential for catalyst particles to break under polymerization conditions. In some instances, the prepolymerized catalyst produces bigger polymer particles and reduces the formation of fines.

In some instances, polymerization plants are not equipped with a prepolymerization section directly connected to the main polymerization reactor. In some of those instances, the prepolymerized catalyst is fed to the polymerization reactor from a separate batch prepolymerization unit, providing prepolymerized catalyst with an amount of prepolymer per catalyst unit lower than that obtained in the on-line prepolymerization.

In some instances, the batch prepolymerized catalyst is dispersed in an oily slurry. In some instances and prior to use, the slurry is diluted with a hydrocarbon medium and stirred for homogenization.

### SUMMARY OF THE INVENTION

In a general embodiment, the present disclosure provides a prepolymerized catalyst component for the polymerization of olefins made from or containing (i) a solid catalyst component made from or containing Ti, Mg, and an internal donor mixture (IDM) made from or containing (a) from 15 to 75% of 1,3-diethers and (b) from 25 to 85% of succinates based on the total molar amount of 1,3-diethers and succinates, and (ii) an amount of an ethylene polymer ranging from 0.1 up to 3.0 g per g of the solid catalyst component (i), wherein the prepolymerized catalyst component has an intrinsic viscosity [η] in tetraline at 135° C. ranging from 2.50 to 5.20 dl/g.

### DETAILED DESCRIPTION OF THE INVENTION

In some embodiments, the prepolymerized solid catalyst component has an average particle size (P50) ranging from 15 to 100 μm, alternatively from 20 to 80 μm, alternatively from 25 to 75 μm.

In some embodiments, the prepolymerized catalyst has a porosity due to pores with radius up to 1 μm of less than 0.25 cm³/g, alternatively less than 0.20 cm³/g, alternatively ranging from 0.05 to 0.20 cm³/g.

In some embodiments, the 1,3-diethers have formula (I)

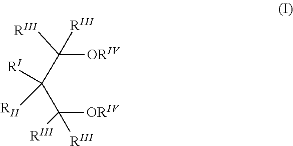

wherein R^{I} and R^{II} are the same or different and are hydrogen or linear or branched C₁-C₁₈ hydrocarbon groups; R^{III} groups, equal or different from each other, are hydrogen or C₁-C₁₈ hydrocarbon groups; R^{IV} groups equal or different from each other, have the same meaning of R^{III} except that R^{IV} groups are not hydrogen. In some embodiments, R^{I} or R^{II} has constituents of cyclic structures. In some embodiments, each of R^{I} to R^{IV} groups contains heteroatoms selected from halogens, N, O, S, and Si.

In some embodiments, R^{IV} is a 1-6 carbon atom alkyl radical, alternatively a methyl. In some embodiments, the R^{III} radicals are hydrogen. In some embodiments, R^{I} is selected from the group consisting of methyl, ethyl, propyl, and isopropyl while R^{II} is selected from the group consisting of ethyl, propyl, isopropyl, butyl, isobutyl, tert-butyl, isopentyl, 2-ethylhexyl, cyclopentyl, cyclohexyl, methylcyclohexyl, phenyl, and benzyl. In some embodiments, R^{I} is hydrogen while R^{II} is selected from the group consisting of ethyl, butyl, sec-butyl, tert-butyl, 2-ethylhexyl, cyclohexylethyl, diphenylmethyl, p-chlorophenyl, 1-naphthyl, and 1-decahydronaphthyl. In some embodiments, R^{I} and R^{II} are the same and selected from the group consisting of ethyl, propyl, isopropyl, butyl, isobutyl, tert-butyl, neopentyl, phenyl, benzyl, cyclohexyl, and cyclopentyl.

In some embodiments, the 1,3-diethers are selected from the group consisting of 2-(2-ethylhexyl)1,3-dimethoxypropane, 2-isopropyl-1,3-dimethoxypropane, 2-butyl-1,3-dimethoxypropane, 2-sec-butyl-1,3-dimethoxypropane, 2-cyclohexyl-1,3-dimethoxypropane, 2-phenyl-1,3-dimethoxypropane, 2-tert-butyl-1,3-dimethoxypropane, 2-cumyl-1,3-dimethoxypropane, 2-(2-phenylethyl)-1,3-dimethoxypropane, 2-(2-cyclohexylethyl)-1,3-dimethoxypropane, 2-(p-chlorophenyl)-1,3-dimethoxypropane, 2-(diphenylmethyl)-1,3-dimethoxypropane, 2(1-naphthyl)-1,3-dimethoxypropane, 2(p-fluorophenyl)-1,3-dimethoxypropane, 2(1-decahydronaphthyl)-1,3-dimethoxypropane, 2(p-tert-butylphenyl)-1,3-dimethoxypropane, 2,2-dicyclohexyl-1,3-dimethoxypropane, 2,2-diethyl-1,3-dimethoxypropane, 2,2-dipropyl-1,3-dimethoxypropane, 2,2-dibutyl-1,3-dimethoxypropane, 2,2-diethyl-1,3-diethoxypropane, 2,2-dicyclopentyl-1,3-dimethoxypropane, 2,2-dipropyl-1,3-diethoxypropane, 2,2-dibutyl-1,3-diethoxypropane, 2-methyl-2-ethyl-1,3-dimethoxypropane, 2-methyl-2-propyl-1,3-dimethoxypropane, 2-methyl-2-benzyl-1,3-dimethoxypropane, 2-methyl-2-phenyl-1,3-dimethoxypropane, 2-methyl-2-cyclohexyl-1,3-dimethoxypropane, 2-methyl-2-methylcyclohexyl-1,3-dimethoxypropane, 2,2-bis(p-chlorophenyl)-1,3-dimethoxypropane, 2,2-bis(2-phenylethyl)-1,3-dimethoxypropane, 2,2-bis(2-cyclohexylethyl)-1,3-dimethoxypropane, 2-methyl-2-isobutyl-1,3-dimethoxypropane, 2-methyl-2-(2-ethylhexyl)-1,3-dimethoxypropane, 2,2-bis(2-ethylhexyl)-1,3-dimethoxypropane, 2,2-bis(p-methylphenyl)-1,3-dimethoxypropane, 2-methyl-2-isopropyl-1,3-dimethoxypropane, 2,2-diisobutyl-1,3-dimethoxypropane, 2,2-diphenyl-1,3-dimethoxypropane, 2,2-dibenzyl-1,3-dimethoxypropane, 2-isopropyl-2-cyclopentyl-1,3-dimethoxypropane, 2,2-bis(cyclohexylmethyl)-1,3-dimethoxypropane, 2,2-diisobutyl-1,3-diethoxypropane, 2,2-diisobutyl-1,3-dibutoxypropane, 2-isobutyl-2-isopropyl-1,3-dimetoxypropane, 2,2-di-sec-butyl-1,3-dimetoxypropane, 2,2-di-tert-butyl-1,3-dimethoxypropane, 2,2-dineopentyl-1,3-dimethoxypropane, 2-iso-propyl-2-isopentyl-1,3-dimethoxypropane, 2-phenyl-2-benzyl-1,3-dimetoxypropane, and 2-cyclohexyl-2-cyclohexylmethyl-1,3-dimethoxypropane.

In some embodiments, the 1,3-diethers have formula (II)

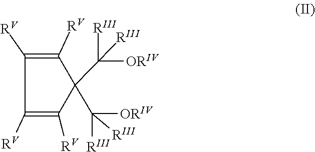

wherein the radicals R^{IV} have the same meaning defined in formula (I) and the radicals R^{III} and R^{V}, equal or different to each other, are selected from the group consisting of hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ arylalkyl radicals. In some embodiments, two or more of the R^{V} radicals are bonded to each other to form condensed cyclic structures, saturated or unsaturated, optionally substituted with R^{VI} radicals. In some embodiments, R^{VI} radicals are selected from the group consisting of halogens; C₁-C₂₀ alkyl radicals, linear or branched; C₃-C₂₀ cycloalkyl, C₆-C₂₀ aryl, C₇-C₂₀ alkylaryl and C₇-C₂₀ arylalkyl radicals. In some embodiments, the halogens are selected from the group consisting of Cl and F. In some embodiments, the radicals R^{V} and R^{VI} contain one or more heteroatoms as substitutes for carbon or hydrogen atoms, or both.

In some embodiments and in the 1,3-diethers of formulae (I) and (II), the R^{III} radicals are hydrogen, and the R^{IV} radicals are methyl. In some embodiments, the 1,3-diethers of formula (II) have two or more of the R^{V} radicals bonded to each other, thereby forming one or more condensed cyclic structures, optionally substituted by R^{VI} radicals. In some embodiments, the condensed cyclic structures are benzenic. In some embodiments, the 1,3-diethers have formula (III):

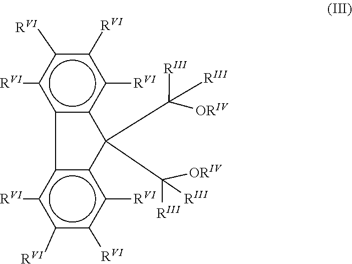

wherein the R^{III} and R^{IV} radicals have the same meaning defined in formula (I), R^{VI} radicals equal or different are hydrogen; halogens; C₁-C₂₀ alkyl radicals, linear or branched; C₃-C₂₀ cycloalkyl, C₆-C₂₀ aryl, C₇-C₂₀ alkylaryl, and C₇-C₂₀ aralkyl radicals, optionally containing one or more heteroatoms selected from the group consisting of N, O, S, P, Si, and halogens, as substitutes for carbon or hydrogen atoms, or both. In some embodiments, the halogens are selected from the group consisting of Cl and F.

In some embodiments, the 1,3-diethers of formulae (II) and (III) are selected from the group consisting of:
1,1-bis(methoxymethyl)-cyclopentadiene;
1,1-bis(methoxymethyl)-2,3,4,5-tetramethylcyclopentadiene;
1,1-bis(methoxymethyl)-2,3,4,5-tetraphenylcyclopentadiene;
1,1-bis(methoxymethyl)-2,3,4,5-tetrafluorocyclopentadiene;
1,1-bis(methoxymethyl)-3,4-dicyclopentylcyclopentadiene;
1,1-bis(methoxymethyl)indene; 1,1-bis(methoxymethyl)-2,3-dimethylindene;
1,1-bis(methoxymethyl)-4,5,6,7-tetrahydroindene;
1,1-bis(methoxymethyl)-2,3,6,7-tetrafluoroindene;
1,1-bis(methoxymethyl)-4,7-dimethylindene;
1,1-bis(methoxymethyl)-3,6-dimethylindene;
1,1-bis(methoxymethyl)-4-phenylindene;
1,1-bis(methoxymethyl)-4-phenyl-2-methylindene;
1,1-bis(methoxymethyl)-4-cyclohexylindene;
1,1-bis(methoxymethyl)-7-(3,3,3-trifluoropropyl)indene;
1,1-bis(methoxymethyl)-7-trimethyisilylindene;
1,1-bis(methoxymethyl)-7-trifluoromethylindene;
1,1-bis(methoxymethyl)-4,7-dimethyl-4,5,6,7-tetrahydroindene;
1,1-bis(methoxymethyl)-7-methylindene;
1,1-bis(methoxymethyl)-7-cyclopenthylindene;
1,1-bis(methoxymethyl)-7-isopropylindene;
1,1-bis(methoxymethyl)-7-cyclohexylindene;
1,1-bis(methoxymethyl)-7-tert-butylindene;
1,1-bis(methoxymethyl)-7-tert-butyl-2-methylindene;
1,1-bis(methoxymethyl)-7-phenylindene;
1,1-bis(methoxymethyl)-2-phenylindene;
1,1-bis(methoxymethyl)-1H-benz[e]indene;
1,1-bis(methoxymethyl)-1H-2-methylbenz[e]indene;
9,9-bis(methoxymethyl)fluorene;
9,9-bis(methoxymethyl)-2,3,6,7-tetramethylfluorene;
9,9-bis(methoxymethyl)-2,3,4,5,6,7-hexafluorofluorene;
9,9-bis(methoxymethyl)-2,3-benzofluorene;
9,9-bis(methoxymethyl)-2,3,6,7-dibenzofluorene;
9,9-bis(methoxymethyl)-2,7-diisopropylfluorene;
9,9-bis(methoxymethyl)-1,8-dichlorofluorene;
9,9-bis(methoxymethyl)-2,7-dicyclopentylfluorene;
9,9-bis(methoxymethyl)-1,8-difluorofluorene;
9,9-bis(methoxymethyl)-1,2,3,4-tetrahydrofluorene;
9,9-bis(methoxymethyl)-1,2,3,4,5,6,7,8-octahydrofluorene; and
9,9-bis(methoxymethyl)-4-tert-butylfluorene.

In some embodiments, the succinates have formula (IV):

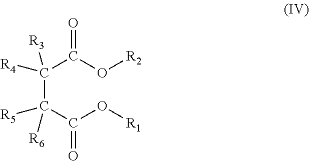

wherein the radicals R₁ and R₂, equal to or different from each other, are a C₁-C₂₀ linear or branched alkyl, alkenyl, cycloalkyl, aryl, arylalkyl, or alkylaryl group, optionally containing heteroatoms; the radicals R₃ to R₆ equal to or different from each other, are hydrogen or a C₁-C₂₀ linear or branched alkyl, alkenyl, cycloalkyl, aryl, arylalkyl, or alkylaryl group, optionally containing heteroatoms. In some embodiments, the radicals R₃ to R₆, which are joined to the same carbon atom of the succinate chain, are linked together to form a cycle.

In some embodiments, R₁ and R₂ are selected from the group consisting of C₁-C₈ alkyl, cycloalkyl, aryl, arylalkyl, and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, R₃ to R₅ are hydrogen and R₆ is a branched alkyl, cycloalkyl, aryl, arylalkyl and alkylaryl radical having from 3 to 10 carbon atoms. In some embodiments, the monosubstituted succinate compounds are selected from the group consisting of diethyl sec-butylsuccinate, diethyl thexylsuccinate, diethyl cyclopropylsuccinate, diethyl norbornylsuccinate, diethyl trimethylsilylsuccinate, diethyl methoxysuccinate, diethyl p-methoxyphenylsuccinate, diethyl p-chlorophenylsuccinate diethyl phenylsuccinate, diethyl cyclohexylsuccinate, diethyl benzylsuccinate, diethyl cyclohexylmethylsuccinate, diethyl t-butylsuccinate, diethyl isobutylsuccinate, diethyl isopropylsuccinate, diethyl neopentylsuccinate, diethyl isopentylsuccinate, diethyl (1-trifluoromethylethyl)succinate, diethyl fluorenylsuccinate, diisobutyl sec-butylsuccinate, diisobutyl thexylsuccinate, diisobutyl cyclopropylsuccinate, diisobutyl norbornylsuccinate, diisobutyl perihydrosuccinate, diisobutyl trimethylsilylsuccinate, diisobutyl methoxysuccinate, Diisobutyl p-methoxyphenylsuccinate, diisobutyl p-chlorophenylsuccinate, diisobutyl cyclohexylsuccinate, diisobutyl benzylsuccinate, diisobutyl cyclohexylmethylsuccinate, diisobutyl t-butylsuccinate, diisobutyl isobutylsuccinate, diisobutyl isopropylsuccinate, diisobutyl neopentylsuccinate, diisobutyl isopentylsuccinate, diisobutyl (1-trifluoromethylethyl)succinate, diisobutyl phenylsuccinate, diisobutyl fluorenylsuccinate, dineopentyl sec-butylsuccinate, dineopentyl thexylsuccinate, dineopentyl cyclopropylsuccinate, dineopentyl norbornylsuccinate, dineopentyl trimethylsilylsuccinate, dineopentyl methoxysuccinate, dineopentyl p-methoxyphenylsuccinate, dineopentyl p-chlorophenylsuccinate dineopentyl phenylsuccinate, dineopentyl cyclohexylsuccinate, dineopentyl benzylsuccinate, dineopentyl cyclohexylmethylsuccinate, dineopenthyl t-butylsuccinate, dineopentyl isobutylsuccinate, dineopentyl isopropylsuccinate, dineopentyl neopentylsuccinate, dineopentyl isopentylsuccinate, dineopentyl (1-trifluoromethylethyl)succinate, and dineopentyl fluorenylsuccinate. In some embodiments, at least two radicals from R₃ to R₆ are different from hydrogen and are selected from C₁-C₂₀ linear or branched alkyl, alkenyl, cycloalkyl, aryl, arylalkyl, or alkylaryl group, optionally containing heteroatoms. In some embodiments, the two radicals different from hydrogen are linked to the same carbon atom. In some embodiments, at least two radicals different from hydrogen are linked to different carbon atoms of the succinate chain, that is, R₃ and R₅ or R₄ and R₆. In some embodiments, the disubstituted succinates are selected from the group consisting of diethyl 2,2-dimethylsuccinate, diethyl 2-ethyl-2-methylsuccinate, diethyl 2-benzyl-2-isopropylsuccinate, diethyl 2-cyclohexylmethyl-2-isobutylsuccinate, diethyl 2-cyclopentyl-2-n-butyl succinate, diethyl 2,2-diisobutylsuccinate, diethyl 2-cyclohexyl-2-ethylsuccinate, diethyl 2-isopropyl-2-methylsuccinate, diethyl 2-tetradecyl-2-ethyl succinate, diethyl 2-isobutyl-2-ethylsuccinate, diethyl 2-(1-trifluoromethyl-ethyl)-2-methylsuccinate, diethyl 2-isopentyl-2-isobutylsuccinate, diethyl 2-phenyl 2-n-butylsuccinate, diisobutyl 2,2-dimethylsuccinate, diisobutyl 2-ethyl-2-methylsuccinate, diisobutyl 2-benzyl-2isopropylsuccinate, diisobutyl 2-cyclohexylmethyl-2-isobutylsuccinate, diisobutyl 2-cyclopentyl-2-n-butylsuccinate, diisobutyl 2,2-diisobutylsuccinate, diisobutyl 2-cyclohexyl-2-ethylsuccinate, diisobutyl 2-isopropyl-2-methylsuccinate, diisobutyl 2-tetradecyl-2-ethylsuccinate, diisobutyl 2-isobutyl-2-ethylsuccinate, diisobutyl 2-(1-trifluoromethyl-ethyl)-2-methylsuccinate, diisobutyl 2-isopentyl-2-isobutylsuccinate, diisobutyl 2-phenyl 2-n-butyl-succinate, dineopentyl 2,2-dimethylsuccinate, dineopentyl 2-ethyl-2-methylsuccinate, dineopentyl 2-Benzyl-2-isopropylsuccinate, dineopentyl 2-cyhexylmethyl-2-isobutylsuccinate, dineopentyl 2-cyclopentyl-2-n-butylsuccinate, dineopentyl 2,2-diisobutylsuccinate, dineopentyl 2-cyclohexyl-2-ethylsuccinate, dineopentyl 2-isopropyl-2-methylsuccinate, dineopentyl 2-tetradecyl-2-ethylsuccinate, dineopentyl 2-isobutyl-2-ethylsuccinate, dineopentyl 2-(1-trifluoromethyl-ethyl)-2-methylsuccinate, dineopentyl 2-isopentyl-2-isobutylsuccinate, and dineopentyl 2-phenyl 2-n-butylsuccinate.

In some embodiments, at least two radicals different from hydrogen are linked to different carbon atoms, that is, R₃ and R₅ or R₄ and R₆. In some embodiments, the compounds are selected from the group consisting of diethyl 2,3bis(trimethylsilyl)succinate, diethyl 2,2-secbutyl-3-methylsuccinate, diethyl 2-(3,3,3,trifluoropropyl)-3-methylsuccinate, diethyl 2,3 bis(2-ethyl-butyl)succinate, diethyl 2,3-diethyl-2-isopropylsuccinate, diethyl 2,3-diisopropyl-2-methylsuccinate, diethyl 2,3-dicyclohexyl-2-methyl diethyl 2,3-dibenzylsuccinate, diethyl 2,3-diisopropylsuccinate, diethyl 2,3-bis(cyclohexylmethyl)succinate, diethyl 2,3-di-t-butylsuccinate, diethyl 2,3-diisobutylsuccinate, diethyl 2,3-dineopentylsuccinate, diethyl 2,3-diisopentylsuccinate, diethyl 2,3-(1-trifluoromethyl-ethyl)succinate, diethyl 2,3-tetradecylsuccinate, diethyl 2,3-fluorenylsuccinate, diethyl 2-isopropyl-3-isobutylsuccinate, diethyl 2-terbutyl-3-isopropylsuccinate, diethyl 2-ipropyl-3-cyclohexylsuccinate, diethyl 2-isopentyl-3-cyclohexylsuccinate, diethyl 2-tetradecyl-3-cyclohexylmethylsuccinate, diethyl 2-cyclohexyl-3-cyclopentylsuccinate. diisobutyl 2,3-diethyll-2-isopropylsuccinate, diisobutyl 2,3-diisopropyl-2-methylsuccinate, diisobutyl 2,3-dicyclohexyl-2-methylsuccinate, diisobutyl 2,3-dibenzylsuccinate, diisobutyl 2,3-diisopropylsuccinate, diisobutyl 2,3-bis(cyclohexylmethyl)succinate, diisobutyl 2,3-di-t-butylsuccinate, diisobutyl 2,3-diisobutylsuccinate, diisobutyl 2,3-dineopentylsuccinate, diisobutyl 2,3-diisopentylsuccinate, diisobutyl 2,3-(1-trifluoromethyl-ethyl)succinate, diisobutyl 2,3-tetradecylsuccinate, diisobutyl 2,3-fluorenylsuccinate, diisobutyl 2-ipropyl-3-ibutylsuccinate, diisobutyl 2-terbutyl-3-ipropylsuccinate, diisobutyl 2-ipropyl-3-cyclohexylsuccinate, diisobutyl 2-isopentyl-3-cyclohexylsuccinate, diisobutyl 2-tetradecyl-3-cyclohexylmethylsuccinate, diisobutyl 2-cyclohexyl-3-cyclopentylsuccinate, dineopentyl 2,3bis(trimethylsilyl)succinate, dineopentyl 2,2-secbutyl-3-methylsuccinate, dineopentyl 2-(3,3,3,trifluoropropyl)-3-methylsuccinate, dineopentyl 2,3 bis(2-ethyl-butyl)succinate, dineopentyl 2,3-diethyl-2-isopropylsuccinate, dineopentyl 2,3-diisopropyl-2-methylsuccinate, dineopentyl 2,3-dicyclohexyl-2-methyl, dineopentyl 2,3-dibenzylsuccinate, dineopentyl 2,3-diisopropylsuccinate, dineopentyl 2,3-bis(cyclohexylmethyl)succinate, dineopentyl 2,3-di-t-butylsuccinate, dineopentyl 2,3-diisobutylsuccinate, dineopentyl 2,3-dineopentylsuccinate, dineopentyl 2,3-diisopentylsuccinate, dineopentyl 2,3-(1-trifluoromethyl-ethyl)succinate, dineopentyl 2,3-tetradecylsuccinate, dineopentyl 2,3-fluorenylsuccinate, dineopentyl 2-ipropyl-3-ibutylsuccinate, dineopentyl 2-terbutyl-3-isopropylsuccinate, dineopentyl 2-isopropyl-3-cyclohexylsuccinate, dineopentyl 2-isopentyl-3-cyclohexylsuccinate, dineopentyl 2-tetradecyl-3-cyclohexylmethyl succinate, and dineopentyl 2-cyclohexyl-3-cyclopentylsuccinate.

In some embodiments, a subclass of succinates has formula (V) below

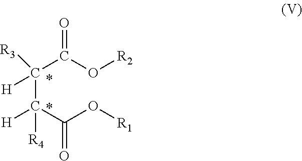

wherein the radicals R₁ and R₂, equal to or different from each other, are a C₁-C₂₀ linear or branched alkyl, alkenyl, cycloalkyl, aryl, arylalkyl, or alkylaryl groups, optionally containing heteroatoms; and the radicals R₃ and R₄, equal to or different from each other, are C₁-C₂₀ alkyl, C₃-C₂₀ cycloalkyl, C₅-C₂₀ aryl, arylalkyl, or alkylaryl groups with the proviso that at least one of R₃ and R₄ is a branched alkyl. In some embodiments, the compounds are, with respect to the two asymmetric carbon atoms identified in the structure of formula (IV), stereoisomers of the type (S,R) or (R,S).

In some embodiments, R₁ and R₂ are selected from the group consisting of C₁-C₈ alkyl, cycloalkyl, aryl, arylalkyl, and alkylaryl groups. In some embodiments, R₁ and R₂ are selected from primary alkyls, alternatively branched primary alkyls. In some embodiments, R₁ and R₂ groups are selected from the group consisting of methyl, ethyl, n-propyl, n-butyl, isobutyl, neopentyl, and 2-ethylhexyl. In some embodiments, R₁ and R₂ groups are selected from the group consisting of ethyl, isobutyl, and neopentyl.

In some embodiments, the R₃ radical, R₄ radical, or both are secondary alkyls or cycloakyls. In some embodiments, the secondary alkyls are selected from the group consisting of isopropyl, sec-butyl, 2-pentyl, and 3-pentyl. In some embodiments, the cycloakyls are selected from the group consisting of cyclohexyl, cyclopentyl, and cyclohexylmethyl.

In some embodiments, the compounds are the (S,R) (S,R) forms pure or in mixture, optionally in racemic form, of compounds selected from the group consisting of diethyl 2,3-bis(trimethylsilyl)succinate, diethyl 2,3-bis(2-ethylbutyl)succinate, diethyl 2,3-dibenzylsuccinate, diethyl 2,3-diisopropylsuccinate, diisobutyl 2,3-diisopropylsuccinate, diethyl 2,3-bis(cyclohexylmethyl)succinate, diethyl 2,3-diisobutylsuccinate, diethyl 2,3-dineopentylsuccinate, diethyl 2,3-dicyclopentylsuccinate, and diethyl 2,3-dicyclohexylsuccinate.

In some embodiments, the internal donor mixture (IDM) contains from 20 to 70% by mol, alternatively from 25 to 65% by mol, alternatively from 35 to 60% by mol, of 1,3 diethers based on the total amount of 1,3-diethers and succinates.

In some embodiments and correspondingly, the amount of succinates in the mixture ranges from 30 to 70% by mol, alternatively from 35 to 75% by mol, alternatively from 45 to 65% by mol.

In some embodiments, additional electron donors different from diethers and succinates are present. In some embodiments, the additional electron donors are present in a lower amount with respect to the IDM. In some embodiments, the additional donors are selected from alcohols or mono carboxylic acid esters. In some embodiments, the additional donors are present in a molar amount less than 30% the amount of the IDM of succinates and 1,3-diethers.

In some embodiments, the (IDM)/Mg molar ratio ranges from 0.030 to 0.20, alternatively from 0.035 to 0.15, alternatively from 0.040 to 0.10.

In some embodiments, the Mg/Ti molar ratio is lower than 13, alternatively lower than 11, alternatively ranges from 5 to 10.

In some embodiments, the amount of ethylene prepolymer in the prepolymerized solid catalyst component ranges from 0.1 up to 1.5 g, alternatively from 0.1 to 1.0 g, alternatively from 0.2 to 0.8 g per g, of the solid catalyst component (i).

In some embodiments, the intrinsic viscosity of the prepolymer ranges from 2.8 to 5.0, alternatively from 3.0 to 4.7, alternatively from 3.2 to 4.5 dl/g.

In some embodiments, the prepolymerized solid catalyst component is obtainable by subjecting an original solid catalyst component containing Mg, Ti, chlorine, and an electron donor selected from 1.3-diethers to prepolymerization conditions in the presence of the olefin monomer and an alkyl-Al compound.

As used herein, the term “prepolymerization conditions” refers to the complex of conditions in terms of temperature, monomer feeding, and amount of reagents for preparing a prepolymerized catalyst component.

In some embodiments, the alkyl-Al compound is selected from the group consisting of trialkyl aluminum compounds and mixtures of trialkylaluminums with alkylaluminum halides, alkylaluminum hydrides, or alkylaluminum sesquichlorides. In some embodiments, the alkyl-Al compound is selected from the group consisting of triethylaluminum, triisobutylaluminum, tri-n-butylaluminum, tri-n-hexylaluminum, and tri-n-octylaluminum. In some embodiments, the alkyl-Al compound is tri-n-octylaluminum. In some embodiments, the alkylaluminum sesquichlorides are selected from the group consisting of AlEt₂Cl and Al₂Et₃Cl₃.

In some embodiments, the prepolymerization uses low amounts of alkyl-Al compound. In some embodiments, the amount of alkyl-Al compound is such that the Al compound/catalyst weight ratio ranges from 0.001 to 10, alternatively from 0.005 to 5, alternatively from 0.005 to 1.5. To achieve a certain intrinsic viscosity, the ethylene feeding ranges from 0.015 to 0.06 gC2⁻/gcat/h, alternatively from 0.02 to 0.055 gC2⁻/gcat/h.

In some embodiments, an external donor is selected from the group consisting of silicon compounds, ethers, esters, amines, heterocyclic compounds, ketones, and 1,3-diethers having formula (I).

In some embodiments, the prepolymerization is carried out in liquid phase, (slurry or bulk) or in gas-phase at temperatures ranging from −20 to 80° C., alternatively from 0° C. to 75° C. In some embodiments, the prepolymerization is carried out in a liquid diluent, alternatively liquid light hydrocarbons. In some embodiments, the hydrocarbons are selected from the group consisting of pentane, hexane, and heptane. In some embodiments, the prepolymerization is carried out in a more viscous medium, alternatively having a kinematic viscosity ranging from 5 to 100 cSt at 40° C. In some embodiments, the medium is a pure substance or a homogeneous mixture of substances having different kinematic viscosity. In some embodiments, the medium is a hydrocarbon medium. In some embodiments, the medium has a kinematic viscosity ranging from 10 to 90 cSt at 40° C.

In some embodiments, the olefin monomer to be prepolymerized is fed in a predetermined amount and in one step in the reactor before the pre-polymerization. In some embodiments, the olefin monomer is continuously supplied to the reactor during polymerization at a certain rate.

In some embodiments, the solid catalyst component (i), before pre-polymerization, has a porosity, measured by the mercury method, due to pores with radius equal to or lower than 1 μm, ranging from 0.15 cm³/g to 1.5 cm³/g, alternatively from 0.3 cm³/g to 0.9 cm³/g, alternatively from 0.4 to 0.9 cm³/g.

In some embodiments, the solid catalyst component (i) is made from or containing an electron donor, a titanium compound having a Ti-halogen bond, and a Mg halide. In some embodiments, the magnesium halide is MgCl₂ in active form.

In some embodiments, the titanium compounds are selected from the group consisting of TiCl₄ and TiCl₃. In some embodiments, the titanium compounds are Ti-haloalcoholates having formula Ti(OR)n-yXy, where n is the valence of titanium, y is a number between 1 and n−1, X is halogen, and R is a hydrocarbon radical having from 1 to 10 carbon atoms.

In some embodiments, the original catalyst component (a) has an average particle size ranging from 20 to 60 μm.

In some embodiments, the prepolymerized catalyst is stored in hydrocarbon slurry before use. In some embodiments, the flowability of the prepolymerized catalyst components allows drum unloading of the catalyst. In some embodiments, the catalyst is subjected to a homogenization step before feeding the catalyst to the polymerization reactor plant. In some embodiments, during the homogenization step, the amount of fine polymer released is negligible with respect to the amount released by other prepolymerized catalysts.

In some embodiments, the prepolymerized catalyst has a flowability (test carried out according to the conditions set forth in the characterization section) of lower than 11 seconds, alternatively lower than 10 seconds.

In some embodiments, the prepolymerized solid catalyst components are reacted with alkylaluminum compounds.

In some embodiments, the present disclosure provides a catalyst for the polymerization of olefins CH₂═CHR, wherein R is hydrogen or a C₁-C₁₂ hydrocarbyl radical made from or containing the product of the reaction between:
(i) the prepolymerized solid catalyst component,
(ii) an alkylaluminum compound and, optionally,
(iii) an external electron donor compound.

In some embodiments, alkyl-Al compound (ii) is selected from the group consisting of trialkyl aluminum compounds and mixtures of trialkylaluminums with alkylaluminum halides, alkylaluminum hydrides, or alkylaluminum sesquichlorides. In some embodiments, the trialkyl aluminum compounds are selected from the group consisting of triethylaluminum, tri-n-hexylaluminum, and tri-n-octylaluminum. In some embodiments, the alkylaluminum sesquichlorides are selected from the group consisting of AlEt₂Cl and Al₂Et₃Cl₃. In some embodiments, the alkyl-Al compound (ii) is the same as the alkyl-Al compound used in the pre-polymerization.

In some embodiments, the amount of the aluminum alkyl compound used in the gas-phase process is such that the Al/Ti molar ratio ranges from 10 to 400, alternatively from 30 to 250, alternatively from 40 to 200.

In some embodiments, the catalyst system is further made from or containing external electron-donors (ED) selected from the group consisting of silicon compounds, ethers, esters, amines, heterocyclic compounds, and ketones. In some embodiments, the ethers are the 1,3 diethers also disclosed as internal donors in the solid catalyst component (a). In some embodiments, the esters are the esters of aliphatic saturated mono or dicarboxylic acids. In some embodiments, the esters are selected from the group consisting of malonates, succinates, and glutarates. In some embodiments, the heterocyclic compound is 2,2,6,6-tetramethyl piperidine. In some embodiments, the silicon compounds have a Si—O—C bond. In some embodiments, the silicon compounds have formula Ra⁵Rb⁶Si(OR⁷)c, wherein a and b are integer from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms selected from the group consisting of N, O, halogen, and P. In some embodiments, the silicon compounds are selected from the group consisting of methylcyclohexyldimethoxysilane, diphenyldimethoxysilane, methyl-t-butyldimethoxysilane, dicyclopentyldimethoxysilane, 2-ethylpiperidinyl-2-t-butyldimethoxysilane, 1,1,1,trifluoropropyl-2-ethylpiperidinyl-dimethoxysilane, and 1,1,1,trifluoropropyl-methyl-dimethoxysilane. In some embodiments, the amount of external electron donor compound provides a molar ratio between the alkylaluminum compound and the electron donor compound of from 2 to 500, alternatively from 5 to 350, alternatively from 7 to 200, alternatively from 7 to 150.

In some embodiments, the prepolymerized catalyst is use for gas-phase polymerization. In some embodiments, the gas-phase polymerization is carried out in one or more fluidized or mechanically agitated bed reactors. In the fluidized bed reactors, the fluidization is obtained by a stream of inert fluidization gas the velocity of which is not higher than transport velocity. In some embodiment and as a consequence, the bed of fluidized particles is in a more or less confined zone of the reactor. In the mechanically agitated bed reactor, the polymer bed is kept in place by the gas flow generated by the continuous blade movement, which also determines the height of the bed. In some embodiments, the operating temperature is between 50 and 85° C., alternatively between 60 and 85° C. In some embodiments, the operating pressure ranges from 0.5 and 8 MPa, alternatively between 1 and 5 MPa, alternatively between 1.0 and 3.0 MPa. In some embodiments, inert fluidization gases dissipate the heat generated by the polymerization reaction. In some embodiments, the inert fluidization gases are selected from the group consisting of nitrogen and saturated light hydrocarbons. In some embodiments, the saturated light hydrocarbons are selected from the group consisting of propane, pentane, hexane, and mixtures thereof.

In some embodiments, the polymer molecular weight is controlled by hydrogen or another molecular weight regulator. In some embodiments, the molecular weight regulator is ZnEt₂. In some embodiments, hydrogen is used, the hydrogen/propylene molar ratio ranges from 0.0002 and 0.5, and the propylene monomer is present in an amount from 20% to 100% by volume, alternatively from 30 to 70% by volume, based on the total volume of the gases present in the reactor. In some embodiments, the remaining portion of the feeding mixture is made from or containing inert gases and, optionally, one or more α-olefin comonomers.

In some embodiments, the catalyst is used in gas-phase polymerization devices having at least two interconnected polymerization zones. In some embodiments, the process is carried out in first and second interconnected polymerization zones to which propylene and ethylene or propylene and alpha-olefins are fed in the presence of a catalyst system and from which the polymer produced is discharged. The growing polymer particles flow through the first polymerization zone (riser) under fast fluidization conditions, leave the first polymerization zone, enter the second polymerization zone (downcomer) through which the growing polymer particles flow in a densified form under the action of gravity, leave the second polymerization zone, and are reintroduced into the first polymerization zone, thereby establishing a circulation of polymer between the two polymerization zones. In some embodiments, the conditions of fast fluidization in the first polymerization zone are established by feeding the monomer gas mixture below the point of reintroduction of the growing polymer into the first polymerization zone. In some embodiments, the velocity of the transport gas into the first polymerization zone is higher than the transport velocity under the operating conditions, alternatively between 2 and 15 m/s. In the second polymerization zone, where the polymer flows in densified form under the action of gravity, high values of density of the solid are reached which approach the bulk density of the polymer. In some embodiments, a positive gain in pressure is obtained along the direction of flow, thereby permitting reintroduction of the polymer into the first reaction zone without mechanical devices. In this way, a “loop” circulation is set up, which is defined by the balance of pressures between the two polymerization zones and by the head loss introduced into the system. In some embodiments, one or more inert gases, such as nitrogen or an aliphatic hydrocarbon, are maintained in the polymerization zones, in such quantities that the sum of the partial pressures of the inert gases is between 5 and 80% of the total pressure of the gases. In some embodiments, the operating temperature ranges from 50 and 85° C., alternatively between 60 and 85° C. In some embodiments, the operating pressure ranges from 0.5 to 10 MPa, alternatively between 1.5 and 6 MPa. In some embodiments, the catalyst components are fed to the first polymerization zone. In some embodiments, the catalyst components are fed to the second polymerization zone. In some embodiments, a molecular weight regulator is used. In some embodiments and as described in Patent Cooperation Treaty Publication No. WO00/02929, the gas mixture present in the riser is prevented, alternatively partially prevented, from entering the downcomer. In some embodiments, prevention is achieved by introducing in the downer a gas and/or liquid mixture having a composition different from the gas mixture present in the riser. In some embodiments, the introduction into the downcomer of the gas and/or liquid mixture having a composition different from the gas mixture present in the riser prevent the latter gas mixture from entering the downcomer. In some embodiments, two interconnected polymerization zones having different monomer compositions are obtained, thereby producing polymers with different properties.

In some embodiments, the resulting propylene polymers have high bulk density, alternatively over 0.40 g/cm³, alternatively over 0.42 g/cm³, when tamped. In some embodiments, the resulting propylene polymers have a molecular weight distribution expressed by a polydispersity index (PI) ranging from 4.0 to 7.0, alternatively from 4.5 to 6.5. In some embodiments, the resulting propylene polymers are used to prepare bioriented polypropylene films. In some embodiments, the Melt Flow Rate of the polymer ranges from 0.1 to 100 g/10′, alternatively from 1 to 70 g/10′.

### EXAMPLES

The following examples are to illustrate the disclosure without limiting the scope of the disclosure.

### Characterization

Determination of X.I. 2.5 g of polymer were dissolved in 250 ml of o-xylene under stirring at 135° C. for 30 minutes. The resulting solution was cooled to 25° C. After 30 minutes, the insoluble polymer was filtered. The resulting solution was evaporated in nitrogen flow. The residue was dried and weighed to determine the percentage of soluble polymer and then, by difference, the X.I. %.

### Determination of Mg, Ti

The determination of Mg and Ti (TOT) content in the solid catalyst component was carried out via inductively coupled plasma emission spectroscopy on “I.C.P Spectrometer ARL Accuris”.

The sample was prepared by analytically weighing, in a “Fluxy” platinum crucible”, 0.1÷0.3 grams of catalyst and 2 grams of lithium metaborate/tetraborate 1/1 mixture. After addition of some drops of KI solution, the content of the crucible was subjected to complete burning. The residue was collected with a 5% v/v HNO₃ solution and then analyzed via ICP at the following wavelengths: magnesium, 279.08 nm; titanium, 368.52 nm;
Determination of Electron donors: via Gas-Chromatography analysis

### Average Particle Size of the Adduct, Catalysts and Prepolymers

Determined by a method based on the principle of the optical diffraction of monochromatic laser light with the “Malvern Instr. 2600” apparatus. The average size is given as P50.

### Determination of Polydispersity Index (PI)

Molten polymer was submitted to a dynamic test in rate sweep with a parallel plate rheometer, at temperature of 200° C., according to the ISO 6721-10. G′ (storage modulus) and G″ (loss modulus) were measured as function of frequency. From the rate sweep data, PI is defined by PI=105/Gc, wherein Gc is the crossover modulus as value of modulus at G′=G″.

### Bulk Density and Flowability (Pourability) ASTM D 1895/96 Method A

Drum Unloading Evaluation: The oily catalyst slurry contained in a drum turned upside down flows under the action of gravity through a pipe of 6 mm diameter. Combination of capability and velocity of flowing form the criterion for evaluation: 1=good; 2=acceptable; 3=bad.

### Melt Flow Rate (MFR)

Determined according to ISO 1133 (230° C., 2.16 Kg)

Porosity and Surface Area with Mercury:

The measure was carried out using a “Porosimeter 2000 Series” by Carlo Erba.

The porosity was determined by absorption of mercury under pressure. A calibrated dilatometer (diameter 3 mm) CD3 (Carlo Erba) was connected to a reservoir of mercury and a high-vacuum pump (1·10-2 mbar). A weighed sample was placed in the dilatometer. The apparatus was placed under high vacuum (<0.1 mm Hg) and maintained for 20 minutes. The dilatometer was then connected to the mercury reservoir. The mercury flowed slowly into the dilatometer until the mercury's level reached a height of 10 cm. The valve to the vacuum pump was closed. The mercury pressure was gradually increased with nitrogen up to 140 kg/cm². Under the effect of the pressure, the mercury entered the pores. The level decreased according to the porosity of the material.

The porosity (cm³/g), due to pores up to 1 μm for catalysts (10 μm for polymers), the pore distribution curve, and the average pore size were directly calculated from the integral pore distribution curve, which was function of the volume reduction of the mercury and applied pressure values. The data was provided and evaluated by the porosimeter-associated computer equipped with a “MILESTONE 200/2.04” program by C. Erba.

Intrinsic viscosity: determined in tetrahydronaphthalene at 135° C.

5 g of prepolymerized catalyst were treated under stirring for 30 min. with a mixture made from or containing water (50 ml), acetone (50 ml), and HCl (20 ml) and then filtered. After washings with water and acetone, the residue was dried in oven under vacuum at 70° C. for 2 hours.

The resulting sample was dissolved in tetrahydronaphthalene at 135° C. The solution was poured into the capillary viscometer. The viscometer tube (Ubbelohde type) was surrounded by a cylindrical glass jacket; this setup allowed for temperature control with a circulating thermostatic liquid. The passage of the meniscus in front of the upper lamp started the counter which had a quartz crystal oscillator. The counter stopped as the meniscus passed the lower lamp. The efflux time was registered and converted into a value of intrinsic viscosity through Huggins' equation, using the flow time of the pure solvent at the same experimental conditions (same viscometer and same temperature). A single polymer solution was used to determine [η].

General Procedure for the Preparation of MgCl₂·(EtOH)ₘ Adducts.

An initial amount of microspheroidal MgCl₂·2.8C₂H₅OH was prepared according to the method described in Example 2 of U.S. Pat. No. 4,399,054 but operating at 3,000 rpm instead of 10,000. The final particle size was determined to be P₅₀=28 μm.

### Preparation of Solid Catalyst Component—General Procedure.

Into a 2.0 liter round bottom flask, equipped with a mechanical stirrer, a cooler, and a thermometer, 1.0 liter of TiCl₄ was introduced at room temperature under nitrogen atmosphere. After cooling at −5° C., while stirring, 50 g of microspheroidal were introduced. The temperature was then raised from −5° C. to 40° C. at a speed of 0.4° C./min. An amount of diethyl 2,3-diisopropylsuccinate in racemic form was added such that the Mg/succinate molar ratio of 20. The temperature was raised to 120° C. and maintained for 60 min. After siphoning, fresh TiCl₄ and an amount of 9,9-bis(methoxymethyl)fluorene were added such that the Mg/diether molar ratio of 10. The temperature was raised to 100° C. for 30 min. The treatment with TiCl₄ was repeated at 90° C. for 30 min. The solid was washed six times with anhydrous hexane (6×100 ml) at 60° C.

The solid was dried under vacuum and analyzed. Catalyst composition: Mg=15.4 wt %; Ti=3.3 wt %; diethyl 2,3-diisopropylsuccinate 6.2 wt %; 9,9-bis(methoxymethyl)fluorene 5.0% wt.

### General Procedure for Propylene Polymerization Test

A 4 liter steel autoclave, equipped with a stirrer, a pressure gauge, a thermometer, a catalyst feeding system, monomer feeding lines, and thermostatic jacket, was used. The reactor was charged with 0.008 gr. of solid catalyst component 0.36 g of TEAL, 3.2 liters of propylene, and 1.5 liters of hydrogen. The system was heated to 80° C. in 10 min., under stirring, and maintained under these conditions for 60 min. At the end of the polymerization, the polymer was recovered by removing unreacted monomers and drying under vacuum.

### EXAMPLES

### Example 1

### Preparation of the Prepolymerized Catalyst

Into a 2-liter glass-vessel/stainless steel autoclave equipped with a mechanical anchor stirrer, at room temperature and under a nitrogen atmosphere, 1 liter of i-hexane containing 1.3 g of tri-n-octyl aluminum (TNOA) and 80 g of the spherical catalyst were introduced. The stirring was set at about 500 rpm. The internal temperature was set to 20° C. for a time period of 20 minutes. While maintaining constant the temperature of the reactor, ethylene was introduced with a constant flow for about 12.5 hours. The polymerization was discontinued when a conversion of 0.35 g of polymer per g of catalyst was reached. The resulting prepolymerized catalyst was dried under vacuum at room temperature and analyzed. The intrinsic viscosity of the ethylene prepolymer was 3.47 dl/g. The particle size P50=33 μm.

### Example 2

The catalyst component was prepared as described in Example 1, except that the prepolymerization was discontinued after 18 hours of ethylene feeding when a conversion of 0.5 g of polyethylene per g of catalyst was reached. The resulting prepolymerized catalyst was dried under vacuum at room temperature and analyzed. The intrinsic viscosity of the ethylene prepolymer was 4.47 dl/g. The particle size P50=34 μm.

### Comparative Example 1

The catalyst component was prepared as described in Example 1, except that ethylene was fed for a total time of 5.5 hours. The resulting prepolymerized catalyst was dried under vacuum at room temperature and analyzed. The intrinsic viscosity of the ethylene prepolymer was 5.53 dl/g. The particle size P50=33 μm.

### Comparative Example 2

The catalyst component was prepared as described in example 2 of Patent Cooperation Treaty Publication No. WO2017/021122. The resulting prepolymerized catalyst was dried under vacuum at room temperature and analyzed. The intrinsic viscosity of the ethylene prepolymer was 2.3 dl/g. The particle size P50=33 μm.

TABLE 1

| | Ex1 | Ex2 | Comp. 1 | Comp. 2 |
|---|---|---|---|---|
| MIL g/10′ | 5.8 | 7.3 | 3.7 | 8.4 |
| XI wt % | 95.1 | 95.5 | 95.1 | 96.3 |
| Poured Bulk density g/cm³ | 0.39 | 0.42 | 0.38 | 0.39 |
| Tamped Bulk density g/cm³ | 0.433 | 0.45 | 0.42 | 0.40 |
| PI | 5.5 | 5.5 | 5.4 | 3.5 |
| Mileage kg/g | 37 | 35 | 41 | 31 |
| Flowability (seconds) | 8 | 8 | 11 | 9 |
| Drum unloading ranking | 1 | 1 | 3 | 3 |

1. A prepolymerized catalyst component for the polymerization of olefins comprising:
(i) a solid catalyst component comprising Ti, Mg, and an internal donor mixture (IDM) comprising
(a) from 15 to 75% of 1,3-diethers and
(b) from 25 to 85% of succinates,
based on the total molar amount of 1,3-diethers and succinates, and
(ii) an amount of an ethylene polymer ranging from 0.1 up to 3.0 g per g of the solid catalyst component (i),
wherein the prepolymerized catalyst component has an intrinsic viscosity [η] in tetraline at 135° C. ranging from 2.50 to 5.20 dl/g.

2. The prepolymerized catalyst component according to claim 1, wherein the internal donor mixture contains from 20 to 70% by mol of 1,3 diethers based on the total amount of 1,3-diethers and succinates.

3. The prepolymerized catalyst component according to claim 1, wherein the internal donor mixture contains 30 to 70% by mol of succinates based on the total amount of 1,3-diethers and succinates.

4. The prepolymerized catalyst component according to claim 1, wherein the (IDM)/Mg molar ratio ranges from 0.03 to 0.20.

5. The prepolymerized catalyst component according to claim 1, wherein the Mg/Ti molar ratio is lower than 13.

6. The prepolymerized catalyst component according to claim 1, wherein the amount of ethylene prepolymer in the prepolymerized solid catalyst component ranges from 0.1 up to 1.5 g per g of the solid catalyst component (i).

7. The prepolymerized catalyst component according to claim 1, wherein the intrinsic viscosity of the prepolymer ranges from 2.8 to 5.0 dl/g.

8. The prepolymerized catalyst component according to claim 1, having an average particle size (P50) ranging from 15 to 100 μm.

9. The prepolymerized catalyst component according to claim 1, wherein the 1,3 diether has formula (I) 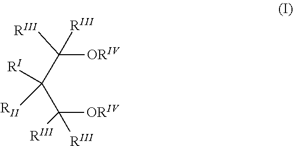
wherein R^{I} and R^{II} are the same or different and are hydrogen or linear or branched C₁-C₁₈ hydrocarbon groups; the R^{III} groups, equal or different from each other, are hydrogen or C₁-C₁₈ hydrocarbon groups; the R^{IV} groups, equal or different from each other, have the same meaning of R^{III} except that R^{IV} groups are not hydrogen.

10. The prepolymerized catalyst component according to claim 1, wherein the succinate has the formula (IV) 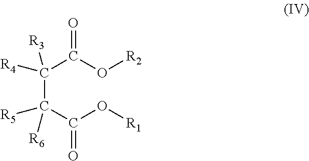
wherein the radicals R1 and R2, equal to or different from each other, are a C₁-C₂₀ linear or branched alkyl, alkenyl, cycloalkyl, aryl, arylalkyl, or alkylaryl group, optionally containing heteroatoms; the radicals R3 to R6 equal to or different from each other, are hydrogen or a C₁-C₂₀ linear or branched alkyl, alkenyl, cycloalkyl, aryl, arylalkyl, or alkylaryl group, optionally containing heteroatoms.

11. A catalyst system for the polymerization of olefins CH₂═CHR, wherein R is hydrogen or a hydrocarbyl radical with 1-12 carbon atoms, comprising
the product of the reaction between:
(i) the prepolymerized solid catalyst component according to claim 1,
(ii) an alkylaluminum compound and, optionally,
(iii) an external electron donor compound.

12. The catalyst system according to claim 11, wherein the external electron donor is selected from silicon compounds having formula Ra⁵Rb⁶Si(OR⁷)c, wherein a and b are integer from 0 to 2, c is an integer from 1 to 3, and the sum (a+b+c) is 4; R⁵, R⁶, and R⁷ are alkyl, cycloalkyl, or aryl radicals with 1-18 carbon atoms optionally containing heteroatoms selected from the group consisting of N, O, halogen, and P.

13. A gas-phase process for the polymerization of olefins CH₂═CHR, wherein R is hydrogen or a C₁-C₁₂ hydrocarbyl group, carried out in the presence of the catalyst system according to claim 11.

14. The gas phase process according to claim 13 carried out for the production of propylene polymers having a Polydispersity Index ranging from 4.0 to 7.0.

15. The gas-phase process according to claim 14 producing propylene polymers for BOPP films.
